(19) United States
(12) Patent Application Publication
(10) Pub. No.: US 2025/0332676 A1
(43) Pub. Date: Oct. 30, 2025

(54) ZERO POINT POSITIONING DEVICE

(71) Applicant: Zhiqiang PAN, Dongguan (CN)

(72) Inventor: Zhiqiang PAN, Dongguan (CN)

(21) Appl. No.: 19/260,358

(22) Filed: Jul. 4, 2025

Related U.S. Application Data
(63) Continuation of application No. PCT/CN2023/130929, filed on Nov. 10, 2023.

(30) Foreign Application Priority Data
Jan. 13, 2023 (CN) 202310070400.9

(51) Int. Cl. B23Q 3/18

(52) U.S. Cl. CPC B23Q 3/18

(57) ABSTRACT

A zero point positioning device is provided. The device includes a base platform and at least two positioners arranged in pairs. The positioners are arranged at intervals on the base platform. Each positioner includes a shell seat mounted on the base platform, a positioning key configured to be inserted into the insertion opening from top to bottom, and a locking assembly provided inside the shell seat. The positioning key includes a positioning portion, a periphery of the positioning portion includes two first positioning surfaces arranged opposite to each other and two second positioning surfaces arranged opposite to each other, the two first positioning surfaces are respectively in clearance fit with the two first mating surfaces, the two second positioning surfaces are respectively mate with and abut against the two second mating surfaces.

### CROSS-REFERENCE TO RELATED APPLICATIONS

This application is a continuation of International Patent Application No. PCT/CN2023/130929, filed Nov. 10, 2023 and claims priority of Chinese Patent Application No. 202310070400.9, filed on Jan. 13, 2023, the entire contents of which are incorporated herein by reference.

### TECHNICAL FIELD

The present disclosure relates to the technical field of machine tool equipment, and particularly to a zero point positioning device.

### BACKGROUND

A zero point positioning device is a positioning and locking device, which can ensure that a work piece to be machined does not undergo offset displacement when moving from one work station to another, from one work process to another, or from one machine tool to another, thus saving the auxiliary time for re-alignment, and improving work efficiency.

Currently, the zero point positioning device generally uses a round dowel pin to directly connect to the work piece to be machined. In order to facilitate connection between the zero point positioning device and the work piece to be machined, a small amount of gap is usually left between the pin and an assembling hole of the work piece to be machined, which will lead to deviation in positioning accuracy, thereby causing displacement.

### SUMMARY

An objective of the present disclosure is to provide a zero point positioning device, so as to solve the problem that a small amount of gap is usually left between the pin and an assembling hole of the work piece to be machined, which will lead to deviation in positioning accuracy, thereby causing displacement.

In order to achieve the above objectives, the present disclosure provides the following solution: a zero point positioning device, including:
a base platform and at least two positioners arranged in pairs, where the at least two positioners are arranged at intervals on the base platform;
each of the at least two positioners includes:
a shell seat mounted on the base platform, where a top surface of the shell seat is provided with an insertion opening, a top of the insertion opening is provided with a mating section, the mating section includes two first mating surfaces arranged opposite to each other and two second mating surfaces arranged opposite to each other, the two first mating surfaces are spaced apart and arranged in parallel, the two second mating surfaces are spaced apart and inclined towards each other from top to bottom, and length directions of the two second mating surfaces of each of the at least two positioners are arranged in parallel in a horizontal plane;
a positioning key configured to be inserted into the insertion opening from top to bottom, where the positioning key includes a positioning portion, a periphery of the positioning portion includes two first positioning surfaces arranged opposite to each other and two second positioning surfaces arranged opposite to each other, the two first positioning surfaces are respectively in clearance fit with the two first mating surfaces, the two second positioning surfaces respectively mate with the two second mating surfaces, a periphery of the positioning key includes locking grooves, and the locking grooves are located below the positioning portion;
a locking assembly provided inside the shell seat, where the locking assembly includes a driving mechanism and locking blocks, the driving mechanism is configured to drive the locking blocks to move between a locking position and an unlocking position; at the locking position of the locking blocks, the locking blocks are respectively clamped in the locking grooves, so as to lock the positioning key on the shell seat; and at the unlocking position of the locking blocks, the locking blocks are respectively disengaged from the locking grooves, so as to enable the positioning key to slide relative to the shell seat;
where in a pair of positioners, length directions of second mating surfaces of a mating portion of one of the pair of positioners intersect those of another of the pair of positioners in the horizontal plane.

In some embodiments, in the pair of positioners, the length directions of the second mating surfaces of the mating portion of the one of the pair of positioners are perpendicular to those of the other of the pair of positioners in the horizontal plane.

In some embodiments, the shell seat includes:
a base shell;
a cover arranged at an upper end of the base shell, where the base shell mates with
the cover to form a slot; and

two fixing blocks mounted on the cover, where the two fixing blocks are embedded in two opposite sides of a top of the slot, a gap is defined between the two fixing blocks, the gap and the slot form the insertion opening, the second mating surfaces are respectively defined and formed on opposite sides of the two fixing blocks, and an interior of each of the two fixing blocks has a hollow structure.

In some embodiments, the positioning key further includes:
a positioning protrusion arranged at a top of the positioning portion and protruding from the top surface of the shell seat; and
a bolt mounted on the positioning protrusion.

In some embodiments, a lower end of the positioning key is provided with guiding slopes inclined toward a center of the positioning key from top to bottom.

In some embodiments, the shell seat is provided with a mounting cavity and sliding rails, the mounting cavity is arranged around an outer periphery of the insertion opening, and the mounting cavity is connected to the insertion opening through the sliding rails;
the driving mechanism includes an annular elastic cavity, springs and abutting plates all arranged in the mounting cavity, the annular clastic cavity is arranged around the insertion opening, the abutting plates are connected to a lower end face of the annular elastic cavity, upper ends of the springs respectively abut against the abutting plates, lower ends of the springs abut against the shell seat, the locking blocks are respectively slidably arranged in the sliding rails, sliding grooves are respectively formed on the abutting plates, the sliding grooves extend and are inclined towards the insertion opening from top to bottom, the locking blocks are provided with guiding posts respectively arranged in the sliding grooves and configured to slide along the sliding grooves; and
the annular elastic cavity is configured to be inflated and deflated to drive the abutting plates to move up and down, so as to drive the locking blocks to respectively slide along the sliding rails and drive the locking blocks to move between the locking position and the unlocking position.

In some embodiments, the annular elastic cavity is defined by the shell seat and an upper side surface of an annular pressing plate provided in the shell seat, the abutting plates are fixedly connected to a lower end face of the annular pressing plate; at the locking position of the locking blocks, the annular pressing plate protrudes upwards; and at the unlocking position of the locking blocks, the annular pressing plate protrudes downwards.

In some embodiments, limiting rods are provided in the shell seat and respectively inserted into the springs, a lower end of each of the abutting plates is provided with a limiting channel for inserting a corresponding one of the limiting rods, a lower end of the limiting channel is provided with a limiting ring protruding towards an interior of the limiting channel, and a limiting protrusion is provided on an upper end of the corresponding one of the limiting rods for limiting upward movement of the limiting ring.

In some embodiments, the annular pressing plate is detachably connected to the shell seat.

In some embodiments, two pairs of positioners are provided on the base platform at intervals, each of the two pairs of positioners includes a first positioner and a second positioner, length directions of second mating surfaces of the first positioner of one of the two pairs of positioners are parallel to those of another of the two pairs of positioners in the horizontal plane, and length directions of second mating surfaces of the second positioner of the one of the two pairs of positioners are parallel to those of the other of the two pairs of positioners in the horizontal plane.

The zero point positioning device of the present disclosure, compared with the relevant art, has the following effect. The second positioning surfaces of the positioning portion mate with the positioning key. In the pair of positioners, when viewed along any transverse section, the second mating surfaces of the two mating portions intersect, thereby limiting the degrees of freedom of the positioning key in the horizontal direction. By locking the locking assembly in the positioner, the positioning key is further constrained in the vertical direction. This ensures precise positioning of the work piece, which is fixedly connected to the positioning key. Meanwhile, the first positioning surfaces are in clearance fit with the first mating surfaces, thereby avoiding the positioning interference caused by being overconstrained.

### BRIEF DESCRIPTION OF THE DRAWINGS

FIG. 1 is a sectional view of a positioner in a zero point positioning device according to Embodiment 1 of the present disclosure in a locking state.

FIG. 2 is a sectional view of the positioner in the zero point positioning device according to Embodiment 1 of the present disclosure in an unlocking state.

FIG. 3 is a sectional view of the positioner in the zero point positioning device according to Embodiment 1 of the present disclosure (without a positioning key inserted) in the locking state.

FIG. 4 is an enlarged view of portion A in FIG. 3.

FIG. 5 is a sectional view of the zero point positioning device connected to a work piece according to Embodiment 1 of the present disclosure.

FIG. 6 is a top view of a pair of positioners of the zero point positioning device according to Embodiment 1 of the present disclosure.

FIG. 7 is a top view of two pairs of positioners in the zero point positioning device according to Embodiment 2 of the present disclosure.

FIG. 8 is an external view of the zero point positioning device according to Embodiment 3 of the present disclosure.

FIG. 9 is a sectional view of an end cover in the zero point positioning device according to Embodiment 3 of the present disclosure.

### DETAILED DESCRIPTION OF THE EMBODIMENTS

In the following, the technical solutions in the embodiments of the present disclosure will be clearly and completely described with reference to the attached drawings. Apparently, the described embodiments are only a part of the embodiments of the present disclosure, but not all the embodiments.

### Embodiment 1

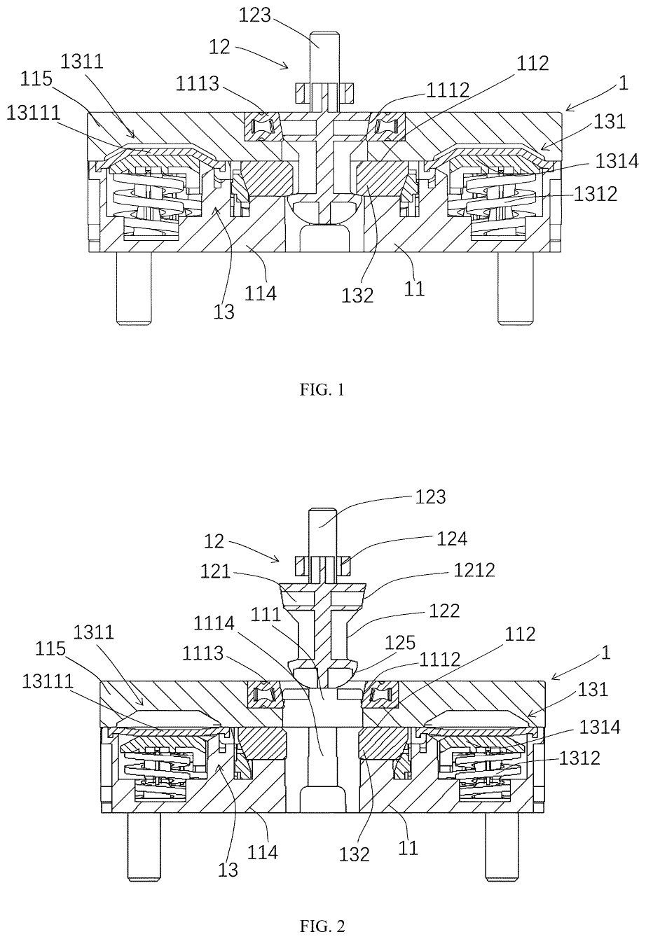

With reference to FIGS. 1 to 3 and 5 to 6, the present disclosure provides a zero point positioning device, which includes a base platform 2 and at least two positioners 1 arranged in pairs, the at least two positioners 1 are arranged at intervals on the base platform 2. By providing multiple pairs of positioners 1, the stress applied to each positioner 1 may be distributed, reducing stress-induced deformation of the positioners 1 and ensuring machining accuracy. Each of the at least two positioners 1 includes a shell seat 11, a positioning key 12 and a locking assembly 13.

The shell seat 11 is mounted on the base platform 2, a top surface of the shell seat 11 is provided with an insertion opening 111, a top of the insertion opening 111 is provided with a mating section, the mating section includes two first mating surfaces 1111 arranged opposite to each other and two second mating surfaces 1112 arranged opposite to each other, the two first mating surfaces 1111 are spaced apart and arranged in parallel, the two second mating surfaces 1112 are spaced apart and inclined towards each other from top to bottom. Length directions of the two second mating surfaces 1112 of each of the at least two positioners 1 are arranged in parallel in a horizontal plane, and when viewed along any transverse section, the two second mating surfaces 1112 are arranged in parallel.

The positioning key 12 is inserted into the insertion opening 111 from top to bottom, the positioning key 12 has a positioning portion 121, a periphery of the positioning portion 121 includes two first positioning surfaces 1211 arranged opposite to each other and two second positioning surfaces 1212 arranged opposite to each other. The two first positioning surfaces 1211 are respectively in clearance fit with the two first mating surfaces 1111, the two second positioning surfaces 1212 respectively mate with the two second mating surfaces 1112, the periphery of the positioning key 12 is provided with locking grooves 122, and the locking grooves 122 are located below the positioning portion 121.

The locking assembly 13 is provided inside the shell seat 11, the locking assembly 13 includes a driving mechanism 131 and locking blocks 132, the driving mechanism 131 is configured to drive the locking blocks 132 to move between a locking position and an unlocking position. When the locking blocks 132 is at the locking position, the locking blocks 132 are respectively clamped in the locking grooves 122, so as to lock the positioning key 12 on the shell seat 11. When the locking blocks 132 is at the unlocking position, the locking blocks 132 are respectively disengaged from the locking grooves 122, so as to enable the positioning key 12 to slide relative to the shell seat 11.

In a pair of positioners 1, length directions of second mating surfaces 1112 of a mating portion of one of the pair of positioners 1 intersect those of another of the pair of positioners 1 in the horizontal plane, i.e., when viewed along any transverse section, the second mating surfaces 1112 of the two mating portions intersect.

Based on this, the second mating surfaces 1112 of the positioning portion 121 clamp the positioning key 12. In the pair of positioners 1, when viewed along any transverse section, the second mating surfaces 1112 of the two mating portions intersect, limiting the horizontal-directional degree of freedom of the positioning key 12. The locking assembly 13 of the positioner 1 locks the positioning key 12, restricting its vertical-directional degree of freedom. This ensures precise positioning of the work piece 3 connected to the positioning key 12. Meanwhile, the first positioning surfaces 1211 are in clearance fit with the first mating surfaces 1111, preventing the positioning interference caused by being overconstrained.

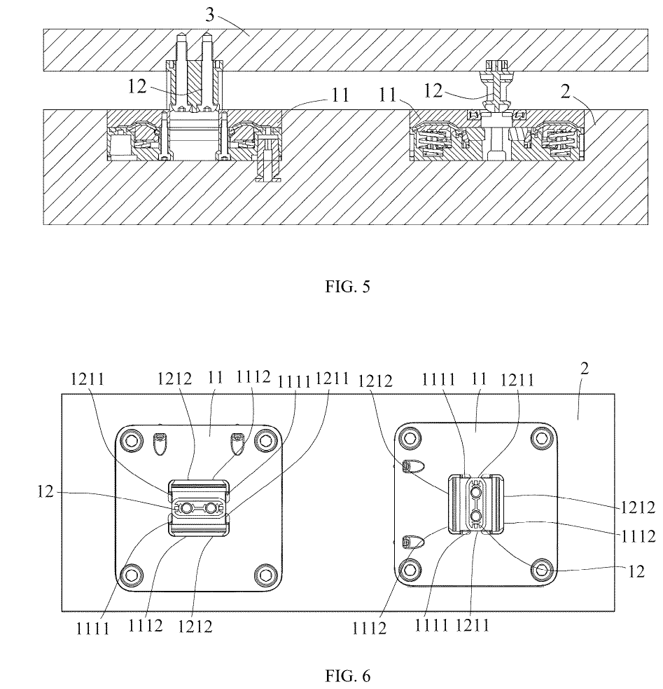

In this embodiment, as shown in FIGS. 5 to 6, in order to reduce over constraining and the installation interference, in the pair of positioners 1, the length directions of the second mating surfaces 1112 of the mating portion of the one of the pair of positioners 1 are perpendicular to those of the other of the pair of positioners 1 in the horizontal plane, i.e., when viewed along any transverse section, the second mating surfaces 1112 of the two mating portions are perpendicular to each other.

In this embodiment, to achieve an interference fit between the second mating surfaces 1112 and the second positioning surfaces 1212 of the positioning portion 121, the second mating surfaces 1112 are made of a flexibility material.

In this embodiment, as shown in FIGS. 1 to 3, to facilitate the installation and removal of the locking assembly 13 inside the shell seat 11, the shell seat 11 includes a base shell 114, a cover 115 and two fixing blocks 1113.

The cover 115 is arranged at an upper end of the base shell 114, the base shell 114 mates with the cover 115 to form a slot 1114, the cover 115 is detachably connected to the base shell 114.

The two fixing blocks 1113 are mounted on the cover 115, the two fixing blocks 1113 are embedded in two opposite sides of a top of the slot 1114, a gap is defined between the two fixing blocks 1113, the gap and the slot 1114 form the insertion opening 111, the second mating surfaces 1112 are respectively defined and formed on the opposite sides of the two fixing blocks 1113, and an interior of each of the two fixing blocks 1113 has a hollow structure. The hollow structure enhances the deformability of the fixing blocks 1113. This increases the pressure applied by the second mating surfaces 1112 onto the second positioning surfaces 1212, resulting in more precise and stable positioning of the positioning key 12.

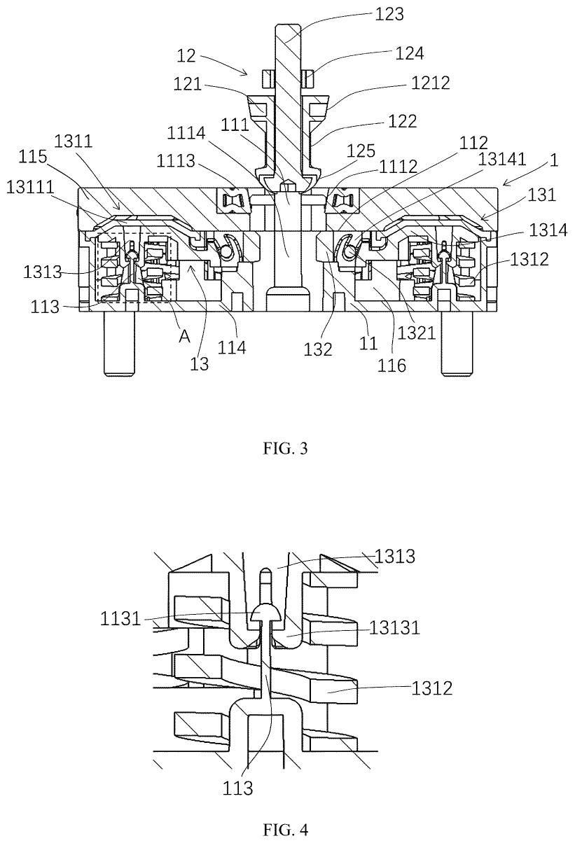

In this embodiment, as shown in FIGS. 2 to 3, the positioning key 12 further includes a positioning protrusion 124 and a bolt 123. The positioning protrusion 124 is arranged at a top of the positioning portion 121, the positioning protrusion 124 may be shaped as a rectangle. It has a through hole (not shown) that connects the upper and lower ends of the positioning protrusion 124, and the positioning portion 121 protrudes from the top surface of the shell seat 11.

The bolt 123 is mounted on the positioning protrusion 124. Specifically, the bolt 123 is inserted through the through hole from bottom to top and is fixedly connected to the positioning protrusion 124. The top of the bolt 123 is fixedly connected to the work piece 3. Further, to facilitate the insertion of the positioning key 12 into the insertion opening 111, a lower end of the positioning key 12 is provided with guiding slopes 125 inclined toward a center of the positioning key 12 from top to bottom.

In this embodiment, as shown in FIG. 3, the shell seat 11 is provided with a mounting cavity 116 and sliding rails 112, the mounting cavity 116 is arranged around an outer periphery of the insertion opening 111, and the mounting cavity 116 is connected to the insertion opening 111 through the sliding rails 112.

The driving mechanism 131 includes an annular clastic cavity 1311, springs 1312 and abutting plates 1314 all arranged in the mounting cavity 116. The annular elastic cavity 1311 is arranged around the insertion opening 111, the abutting plates 1314 are connected to a lower end face of the annular elastic cavity 1311, upper ends of the springs 1312 respectively abut against the abutting plates 1314. Lower ends of the springs 1312 abut against the shell seat 11. The locking blocks 132 are respectively slidably arranged in the sliding rails 112, sliding grooves 13141 are respectively formed on the abutting plates 1314, the sliding grooves 13141 extend and are inclined towards the insertion opening 111 from top to bottom, the locking blocks 132 are provided with guiding posts 1321 respectively arranged in the sliding grooves 13141 and configured to slide along the sliding grooves 13141.

The spring 1312 is always in the compressed state, the annular clastic cavity 1311 may be inflated and deflated to drive the abutting plates 1314 to slide up and down, so as to drive the locking blocks 132 to respectively slide along the sliding rails 112 and drive the locking blocks 132 to move between the locking position and the unlocking position. When the annular elastic cavity 1311 is deflated, the abutting plate 1314 is in the upper position, and the locking block 132 locks the positioning key 12. The purpose of this design is to ensure that the positioner I can fix the positioning key 12 without any energy source, to prevent the positioner 1 from failing to lock the positioning key 12 normally in case of sudden situations such as power outages, which may cause the positioning key 12 to pop out and result in a safety accident.

When the annular clastic cavity 1311 is in the inflated state, the abutting plate 1314 is at the low position and drives the locking block 132 to unlock the positioning key 12. In addition, when the positioning key 12 is not inserted into the insertion opening 111, the locking block 132 is generally in the locking state, as shown in FIG. 3. The locking block 132 will only be in the unlocking state before the positioning key 12 is inserted the insertion opening 111, and when it needs to be pulled out.

Specifically, as shown in FIGS. 1 to 3, the lower surface of the annular elastic cavity 1311 is a rigid surface, thereby enhancing its response speed during inflation and downward pressing. The annular elastic cavity 1311 is defined by the shell seat 11 and an upper side surface of an annular pressing plate 13111 provided in the shell seat 11. The annular pressing plate 13111 is made of an elastic material. When the annular elastic cavity 1311 is inflated, the annular pressing plate 13111 protrudes downward, pushing the abutting plate 1314 to move downward. When the annular elastic cavity 1311 is deflated, the annular pressing plate 13111 protrudes upward, and the spring 1312 rebounds to push the abutting plate 1314 upward. As an example, the annular pressing plate 13111 may be slidably connected to the shell seat 11 in a scaled manner, or a gas bag may be set between the annular pressing plate 13111 and the shell seat 11. The movement of the annular pressing plate 13111 up and down can be controlled by inflating and deflating the gas bag. In this way, the annular pressing plate 13111 can move up and down as a whole. Further, to facilitate the replacement of the annular pressing plate 13111 and the disassembly and assembly of the driving mechanism 131, the annular pressing plate 13111 is detachably connected to the shell seat 11.

In this embodiment, with reference to FIG. 4, in order to limit the compression and extension movements of the spring 1312 within a defined space, a limiting rod 113 is provided inside the shell seat 11 and inserted into the spring 1312, thereby restricting the spring 1312 to expand and compress along the extending direction of the limiting rod 113. To maintain the spring 1312 in a constantly compressed state, a limiting protrusion 1131 is provided on the upper end of the limiting rod 113. A lower end of the abutting plate 1314 is provided with a limiting channel 1313 for inserting the limiting rod 113, a lower end of the limiting channel 1313 is provided with a limiting ring 13131 protruding towards an interior thereof, and the limiting protrusion 1131 is provided on the upper end of the limiting rod 113 for limiting upward movement of the limiting ring 13131. When the annular elastic cavity 1311 discharges air outwards, the spring 1312 squeezes the annular pressing plate 13111 upwards, so that the annular pressing plate 13111 drives the abutting plate 1314 to move upwards. Until the limiting protrusion 1131 comes into contact with the limiting ring 13131, the annular pressing plate 13111 reaches the highest position. The above-mentioned arrangement may effectively ensure that when the locking block 132 is at the unlocking position, the spring 1312 is in the compressed state, ensuring the stable operation of the locking assembly 13.

### Embodiment 2

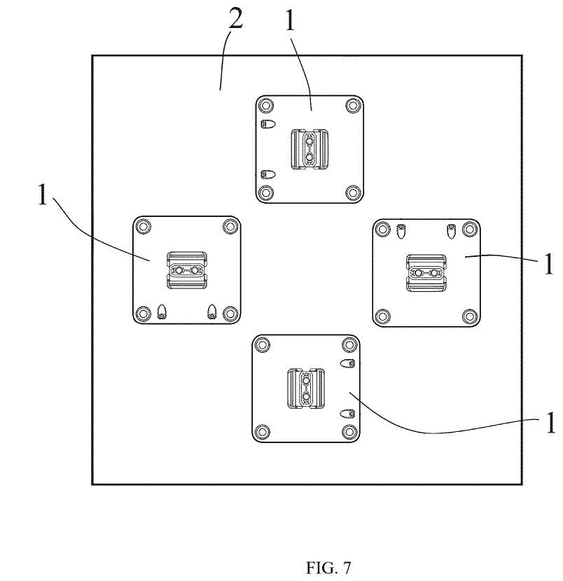

Different from Embodiment 1, Embodiment 2 of the present disclosure provides with two pairs of positioners 1, as shown in FIG. 7. The base platform 2 is provided with two pairs of positioners 1 at intervals. Each pair includes a first positioner 1 and a second positioner 1, length directions of second mating surfaces 1112 of the first positioner 1 of one of the two pairs of positioners 1 are parallel to those of another of the two pairs of positioners 1 in the horizontal plane, and length directions of second mating surfaces 1112 of the second positioner 1 of the one of the two pairs of positioners 1 are parallel to those of the other of the two pairs of positioners 1 in the horizontal plane. Namely, when viewed along any transverse section, the second mating surfaces 1112 of the first positioners are arranged in parallel, and the second mating surfaces 1112 of the second positioners are arranged in parallel.

### Embodiment 3

The differences between Embodiment 3 and Embodiment 1 are as follows.

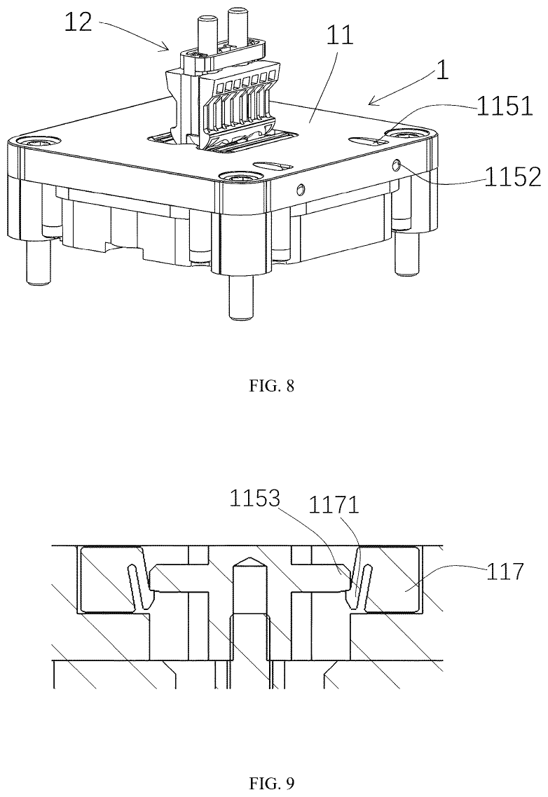

As shown in FIG. 8, a cavity (not shown) is provided inside the positioning key 12. The purpose of the cavity is to allow the positioning key 12 to undergo an interference fit when it is clamped by the locking blocks 132, thereby improving the positioning accuracy of the positioning key 12. Further, without affecting the fixing effect of the bolt 123, the side wall of the through-hole is provided with cavities at intervals (not shown). Without affecting the locking effect between the locking groove 122 and the locking block 132, the outer edge of the locking groove 122 is provided with cavities at intervals. The positioner 1 is provided with a threaded hole 1151 that penetrates the top and side wall of the positioner 1. The threaded hole 1151 is provided with a headless bolt 1152. The positioner 1 abuts against the base platform 2 through the headless bolt 1152 to fix the position relationship between the positioner 1 and the base platform 2, thereby improving the positioning accuracy of the positioner 1.

As shown in FIG. 9, the fixing block 1113 is installed on the cover 115 through the end cover 117. The fixing block 1113 is fixedly connected to the end cover 117. The end cover 117 is provided with a snap-fit portion 1171 extending downward. The cover 115 is provided with a snap-fit block 1153 that is mated with the snap-fit portion 1171. The snap-fit portion 1171 can undergo clastic deformation, so that the end cover 117 is removably connected to the cover 115. The purpose of this arrangement is to facilitate the replacement of the worn-out fixing block 1113 to ensure the precise positioning of the positioning key 12.

The working principle of the present disclosure is as follows. First, the pair of positioning keys 12 are connected to the work piece 3 through the bolts 123. Then, compressed air is introduced into the annular clastic cavity 1311. The annular pressing plate 13111 deforms to protrude downward, pushing the abutting plate 1314 to move downward against the elastic force of the spring 1312. At the same time, the sliding groove 13141 also moves downward. The guiding post 1321 in the sliding groove 13141 is subjected to the pushing force from the sliding groove 13141, driving the locking block 132 to move away from the insertion opening 111, so that the locking block 132 is in the unlocking state, and then the positioning key 12 is inserted into the insertion opening 111. When the locking is required, the annular clastic cavity 1311 is deflated, so that the pressing force on the spring 1312 is reduced, the spring 1312 pushes the abutting plate 1314 to move upward, and the locking block 132 gradually approaches the locking groove 122, and finally the locking of the positioning key 12 is completed.

In summary, the second positioning surfaces 1212 of the positioning portion 121 mate with the positioning key 12. In the pair of positioners 1, when viewed along any transverse sectional plane, the second mating surfaces 1112 of the two mating portions intersect, limiting the horizontal-directional degree of freedom of the positioning key 12. The locking assembly 13 in the positioner 1 locks the positioning key 12, restricting the vertical-directional degree of freedom of the positioning key 12. So that the work piece 3 to be machined, which is fixedly connected to the positioning key 12, may be precisely positioned. Meanwhile, the first positioning surfaces 1211 are in clearance fit with the first mating surfaces 1111, avoiding the positioning interference caused by being overconstrained.

In the description of the present disclosure, it should be understood that the terms “first” and “second” are used to describe various information, but this information should not be limited to these terms, and these terms are only used to distinguish the same type of information from each other. For example, without departing from the scope of the present disclosure, “first” information may also be called “second” information, and similarly, “second” information may also be called “first” information. In addition, “center” “longitudinal”, “transverse”, “up”, “down”, “front”, “back”, “left”, “right”, “vertical”, “horizontal”, “top”, “bottom”, “inside”, “outside”, etc. indicate orientation or positional relationships based on the orientation or positional relationships shown in the accompanying drawings, only for the convenience of describing the present disclosure, and do not indicate or imply that the device or element referred to must have a specific orientation, be constructed and operated in a specific orientation, and therefore cannot be understood as a limitation of the present disclosure.

The above-mentioned embodiments only describe the preferred mode of the present disclosure, and do not limit the scope of the present disclosure. Under the premise of not departing from the design spirit of the present disclosure, various modifications and improvements made by one of ordinary skill in the art to the technical solution of the present disclosure should fall within the protection scope of the present disclosure.

What is claimed is:

1. A zero point positioning device, comprising: a base platform and at least two positioners arranged in pairs, wherein the at least two positioners are arranged at intervals on the base platform;
each of the at least two positioners comprises:
a shell seat mounted on the base platform, wherein a top surface of the shell seat is provided with an insertion opening, a top of the insertion opening is provided with a mating section, the mating section comprises two first mating surfaces arranged opposite to each other and two second mating surfaces arranged opposite to each other, the two first mating surfaces are spaced apart and arranged in parallel, the two second mating surfaces are spaced apart and inclined towards each other from top to bottom, and length directions of the two second mating surfaces of each of the at least two positioners are arranged in parallel in a horizontal plane;
a positioning key configured to be inserted into the insertion opening from top to bottom, wherein the positioning key comprises a positioning portion, a periphery of the positioning portion comprises two first positioning surfaces arranged opposite to each other and two second positioning surfaces arranged opposite to each other, the two first positioning surfaces are respectively in clearance fit with the two first mating surfaces, the two second positioning surfaces respectively mate with the two second mating surfaces, a periphery of the positioning key is provided with locking grooves, and the locking grooves are located below the positioning portion; and
a locking assembly provided inside the shell seat, wherein the locking assembly comprises a driving mechanism and locking blocks, the driving mechanism is configured to drive the locking blocks to move between a locking position and an unlocking position; at the locking position of the locking blocks, the locking blocks are respectively clamped in the locking grooves, so as to lock the positioning key on the shell seat; and at the unlocking position of the locking blocks, the locking blocks are respectively disengaged from the locking grooves, so as to enable the positioning key to slide relative to the shell seat;
wherein in a pair of positioners, length directions of second mating surfaces of a mating portion of one of the pair of positioners intersect those of another of the pair of positioners in the horizontal plane.

2. The zero point positioning device according to claim 1, wherein in the pair of positioners, the length directions of the second mating surfaces of the mating portion of the one of the pair of positioners are perpendicular to those of the other of the pair of positioners in the horizontal plane.

3. The zero point positioning device according to claim 1, wherein the shell seat comprises:
a base shell;
a cover arranged at an upper end of the base shell, wherein the base shell mates with the cover to form a slot; and
two fixing blocks mounted on the cover, wherein the two fixing blocks are embedded in two opposite sides of a top of the slot, a gap is defined between the two fixing blocks, the gap and the slot form the insertion opening, the second mating surfaces are respectively defined and formed on opposite sides of the two fixing blocks, and an interior of each of the two fixing blocks has a hollow structure.

4. The zero point positioning device according to claim 3, wherein the positioning key further comprises:
a positioning protrusion arranged at a top of the positioning portion and protruding from the top surface of the shell seat; and
a bolt mounted on the positioning protrusion.

5. The zero point positioning device according to claim 1, wherein a lower end of the positioning key is provided with guiding slopes inclined toward a center of the positioning key from top to bottom.

6. The zero point positioning device according to claim 1, wherein the shell seat is provided with a mounting cavity and sliding rails, the mounting cavity is arranged around an outer periphery of the insertion opening, and the mounting cavity is connected to the insertion opening through the sliding rails;
the driving mechanism comprises an annular elastic cavity, springs and abutting plates all arranged in the mounting cavity, the annular elastic cavity is arranged around the insertion opening, the abutting plates are connected to a lower end face of the annular elastic cavity, upper ends of the springs respectively abut against the abutting plates, lower ends of the springs abut against the shell seat, the locking blocks are respectively slidably arranged in the sliding rails, sliding grooves are respectively formed on the abutting plates, the sliding grooves extend and are inclined towards the insertion opening from top to bottom, and the locking blocks are provided with guiding posts respectively arranged in the sliding grooves and configured to slide along the sliding grooves; and
the annular elastic cavity is configured to be inflated and deflated to drive the abutting plates to move up and down, so as to drive the locking blocks to respectively slide along the sliding rails and to move between the locking position and the unlocking position.

7. The zero point positioning device according to claim 6, wherein the annular elastic cavity is defined by the shell seat and an upper side surface of an annular pressing plate provided in the shell seat, the abutting plates are fixedly connected to a lower end face of the annular pressing plate; at the locking position of the locking blocks, the annular pressing plate protrudes upwards; and at the unlocking position of the locking blocks, the annular pressing plate protrudes downwards.

8. The zero point positioning device according to claim 7, wherein limiting rods are provided in the shell seat and respectively inserted into the springs, a lower end of each of the abutting plates is provided with a limiting channel for inserting a corresponding one of the limiting rods, a lower end of the limiting channel is provided with a limiting ring protruding towards an interior of the limiting channel, and a limiting protrusion is provided on an upper end of the corresponding one of the limiting rods for limiting upward movement of the limiting ring.

9. The zero point positioning device according to claim 7, wherein the annular pressing plate is detachably connected to the shell seat.

10. The zero point positioning device according to claim 1, wherein two pairs of positioners are provided on the base platform at intervals, each of the two pairs of positioners comprises a first positioner and a second positioner, length directions of second mating surfaces of the first positioner of one of the two pairs of positioners are parallel to those of another of the two pairs of positioners in the horizontal plane, and length directions of second mating surfaces of the second positioner of the one of the two pairs of positioners are parallel to those of the other of the two pairs of positioners in the horizontal plane.
